(19) United States
(12) Patent Application Publication
(10) Pub. No.: US 2026/0274137 A1
(43) Pub. Date: Sep. 17, 2026

(54) PNEUMATIC MASSAGE INTENSIFICATION FOR A VEHICLE SEAT

(71) Applicant: Leggett & Platt Canada Co., Halifax (CA)

(72) Inventors: Asad Sami, LaSalle (CA); Jianfu Mao, Tecumseh (CA); Jacob Friesen, Leamington (CA)

(21) Appl. No.: 19/079,223

(22) Filed: Mar. 13, 2025

(51) Int. Cl. B60N 2/90; B60N 2/66

(52) U.S. Cl. CPC B60N 2/976; B60N 2/665

(57) ABSTRACT

A vehicle seat may include a frame, a back foam, a plurality of adjustable pneumatic bladders positioned within the vehicle seat on an A-surface of the back foam, a source of pressurized air, and a plurality of independently controllable control valves. An electronic processor may be configured to control the plurality of control valves to control the plurality of control valves to provide a wave toggle or a step toggle starting on a first vertical portion of the back foam and moving in a direction up or down to a second vertical portion of the back foam. The electronic processor may be configured to control the plurality of control valves such that the wave toggle or the step toggle continues moving in the direction by controlling the control valves to inflate additional subgroups of bladders located in another vertical portion of the back foam.

### FIELD

The present disclosure relates to a vehicle seat (e.g., seats in aircraft, automobiles, etc.) with pneumatic bladders that are configured to be controlled in certain manners to provide intensified and/or enhanced massage effects to an occupant of the vehicle seat.

### BACKGROUND

Seating for automobiles and similar vehicles has evolved over time. Improvements to seating have been made in the areas of occupant safety, comfort, and convenience. Traditionally, seats include a frame for mounting a seat to the vehicle and have padding and seat covers. More recently, vehicles seats have incorporated powered adjustable positioning, lumbar support, and heating and cooling.

### SUMMARY

Currently available seats may include features that offer a limited number of comfort functions. Some vehicle seats include bladders to provide seating adjustment and/or massaging to an occupant. However, such massaging is often provided without much pressure/intensity and/or is often provided in a less than desirable pattern. Accordingly, there is a technological problem with massage outputs on vehicle seats.

To address this technological problem, the present disclosure provides a vehicle seat with pneumatic bladders that are individually controllable using respective control valves. The vehicle seat also includes an electronic processor configured to control the control valves in certain manners to provide intensified and/or enhanced massage effects to the occupant of the vehicle seat. For example, by controlling the control valves that control the flow of fluid (e.g., air) to one or more bladders to be rapidly opened and/or closed (e.g., in about and/or less than one second, in about and/or less than 0.5 seconds, in about and/or less than 0.25 seconds, and/or the like) for at least a portion of a massage sequence/pattern, the vehicle seat may provide a more intense and/or unique massage/comfort experience to the occupant.

In one aspect, the disclosure provides a vehicle seat that may include a frame, a back foam configured to provide a backrest, a plurality of adjustable pneumatic bladders positioned within the vehicle seat on an A-surface of the back foam, a source of pressurized air, and a plurality of control valves. Each control valve is independently controllable to control whether the pressurized air is provided from the source to a respective bladder to allow for individual control of inflation of each bladder of the plurality of adjustable pneumatic bladders. The vehicle seat may also include an electronic processor coupled to the plurality of control valves to independently control each of the control valves. The electronic processor may be configured to control the plurality of control valves to operate in a first manner to inflate a first bladder on the back foam for a first period of time. The electronic processor may also be configured to, in response to the first period of time elapsing, control, for a second period of time that is shorter than the first period of time, the plurality of control valves to operate in a second manner to stop inflating the first bladder and inflate a first vertically adjacent bladder that is vertically adjacent to the first bladder on the back foam. The electronic processor may also be configured to, in response to the second period of time elapsing, control, for a third period of time that is shorter than the first period of time and longer than the second period of time, the plurality of control valves to operate in a third manner to stop inflating the first vertically adjacent bladder and inflate the first bladder. The electronic processor may also be configured to repeatedly control the plurality of control valves to operate in the second manner for the second period of time and in the third manner for the third period of time in an alternating manner for a predetermined amount of repetitions. The electronic processor may also be configured to, in response to determining that the repeated control of the plurality of control valves in the alternating manner has repeated the predetermined amount of repetitions, control the plurality of control valves to operate in a fourth manner to inflate the first vertically adjacent bladder and to stop inflating the first bladder for a fourth period of time. The electronic processor may also be configured to, in response to the fourth period of time elapsing, control, for the second period of time, the plurality of control valves to operate in a fifth manner to stop inflating the first vertically adjacent bladder and inflate a second vertically adjacent bladder that is vertically adjacent to the first vertically adjacent bladder on the back foam. The first vertically adjacent bladder may be located vertically between the first bladder and the second vertically adjacent bladder on the back foam. The electronic processor may also be configured to, in response to the second period of time elapsing, control, for the third period of time, the plurality of control valves to operate in a sixth manner to stop inflating the second vertically adjacent bladder and inflate the first vertically adjacent bladder. The electronic processor may also be configured to repeatedly control the plurality of control valves to operate in the fifth manner for the second period of time and in the sixth manner for the third period of time in the alternating manner for the predetermined amount of repetitions.

In addition to any combination of features described above, each bladder of the plurality of adjustable pneumatic bladders may include a multi-chamber bladder with multiple chambers oriented in a stacked configuration.

In addition to any combination of features described above, each of the first bladder, the first vertically adjacent bladder, and the second vertically adjacent bladder may include a left bladder and a right bladder.

In addition to any combination of features described above, the second period of time may be between and inclusive of 0.2 seconds and 0.3 seconds.

In addition to any combination of features described above, the third period of time may be between and inclusive of 0.45 second and 0.55 seconds.

In addition to any combination of features described above, the first period of time may be between and inclusive of 2.5 seconds and 3.5 seconds, and the fourth period of time may be between and inclusive of 2.5 seconds and 3.5 seconds.

In addition to any combination of features described above, the first period of time may be the same as the fourth period of time.

In addition to any combination of features described above, the predetermined amount of repetitions may be between and inclusive of two and six.

In addition to any combination of features described above, the first vertically adjacent bladder may include a first next highest bladder above the first bladder, and the second vertically adjacent bladder may include a second next highest bladder above the first next highest bladder.

In addition to any combination of features described above, the electronic processor may be configured to control the plurality of control valves in the first manner, the second manner, the third manner, the fourth manner, the fifth manner, and the sixth manner to provide a wave pulse starting on a lower portion of the back foam and moving upwards to a middle portion of the back foam. In addition to any combination of features described above, the electronic processor may be configured to control the plurality of control valves such that the wave pulse continues upward to a higher portion of the back foam and then restarts at the lower portion of the back foam by controlling the control valves to operate in the first manner for the first period of time.

In another aspect, the disclosure provides a vehicle seat that may include a frame, a back foam configured to provide a backrest, a plurality of adjustable pneumatic bladders positioned within the vehicle seat on an A-surface of the back foam, a source of pressurized air, and a plurality of control valves. Each control valve may be independently controllable to control whether the pressurized air is provided from the source to a respective bladder to allow for individual control of inflation of each bladder of the plurality of adjustable pneumatic bladders. The vehicle seat may also include an electronic processor coupled to the plurality of control valves to independently control each of the control valves. The electronic processor may be configured to control the plurality of control valves to operate in a first manner to inflate a left first bladder and a right first bladder on the back foam for a first period of time. The electronic processor may also be configured to, in response to the first period of time elapsing, control, for a second period of time that is shorter than the first period of time, the plurality of control valves to operate in a second manner to stop inflating one of the left first bladder and the right first bladder while continuing to inflate the other of the left first bladder and the right first bladder. The electronic processor may also be configured to, in response to the second period of time elapsing, control, for the second period of time, the plurality of control valves to operate in a third manner to stop inflating the other of the left first bladder and the right first bladder and inflate the one of the left first bladder and the right first bladder. The electronic processor may also be configured to repeatedly control the plurality of control valves to operate in the second manner for the second period of time and in the third manner for the second period of time in an alternating manner for a predetermined amount of repetitions. The electronic processor may also be configured to, in response to determining that the repeated control of the plurality of control valves in the alternating manner has repeated the predetermined amount of repetitions, control the plurality of control valves to operate in the first manner for a third period of time that is shorter than the first period of time and longer than the second period of time. The electronic processor may also be configured to, in response to the third period of time elapsing, control, for a fourth period of time, the plurality of control valves to operate in a fourth manner to inflate a left vertically adjacent bladder that is vertically adjacent to the left first bladder and a right vertically adjacent bladder that is vertically adjacent to the right first bladder on the back foam and to stop inflating the left first bladder and the right first bladder. The electronic processor may also be configured to, in response to the fourth period of time elapsing, control, for the second period of time, the plurality of control valves to operate in a fifth manner to stop inflating one of the left vertically adjacent bladder and the right vertically adjacent bladder while continuing to inflate the other of the left vertically adjacent bladder and the right vertically adjacent bladder. The electronic processor may also be configured to, in response to the second period of time elapsing, control, for the second period of time, the plurality of control valves to operate in a sixth manner to stop inflating the other of the left vertically adjacent bladder and the right vertically adjacent bladder and inflate the one of the left vertically adjacent bladder and the right vertically adjacent bladder. The electronic processor may also be configured to repeatedly control the plurality of control valves to operate in the fifth manner for the second period of time and in the sixth manner for the second period of time in the alternating manner for the predetermined amount of repetitions. The electronic processor may also be configured to, in response to determining that the repeated control of the plurality of control valves in the alternating manner has repeated the predetermined amount of repetitions, control the plurality of control valves to operate in the fourth manner for a fifth period of time that is shorter than the fourth period of time and longer than the second period of time.

In addition to any combination of features described above, each bladder of the plurality of adjustable pneumatic bladders may include a multi-chamber bladder with multiple chambers oriented in a stacked configuration.

In addition to any combination of features described above, the left first bladder may include a first left low bladder and a second left low bladder that is above the first left low bladder in the back foam. In addition to any combination of features described above, the right first bladder may include a first right low bladder and a second right low bladder that is above the first right low bladder in the back foam. In addition to any combination of features described above, the left vertically adjacent bladder may include a first left vertically adjacent bladder and a second left vertically adjacent bladder that is above the first left vertically adjacent bladder in the back foam. In addition to any combination of features described above, the first left vertically adjacent bladder may be the same as the second left low bladder. In addition to any combination of features described above, the right vertically adjacent bladder may include a first right vertically adjacent bladder and a second right vertically adjacent bladder that is above the first right vertically adjacent bladder in the back foam. In addition to any combination of features described above, the first right vertically adjacent bladder may be the same as the second right low bladder.

In addition to any combination of features described above, the second period of time may be between and inclusive of 0.2 seconds and 0.3 seconds.

In addition to any combination of features described above, the first period of time may be between and inclusive of 2.5 seconds and 3.0 seconds, and the third period of time may be between and inclusive of 1.0 seconds and 1.5 seconds.

In addition to any combination of features described above, the first period of time may be the same as the fourth period of time, and the third period of time may be the same as the fifth period of time.

In addition to any combination of features described above, the predetermined amount of repetitions may be between and inclusive of one and four.

In addition to any combination of features described above, the left vertically adjacent bladder may include a left next highest bladder above the left first bladder, and the right vertically adjacent bladder may include a right next highest bladder above the right first bladder.

In addition to any combination of features described above, the electronic processor may be configured to control the plurality of control valves in the first manner, the second manner, the third manner, the fourth manner, the fifth manner, and the sixth manner to provide a wave toggle or a step toggle starting on a lower portion of the back foam and moving upwards to a middle portion of the back foam. In addition to any combination of features described above, the electronic processor may be configured to control the plurality of control valves such that the wave toggle or the step toggle continues upward to a higher portion of the back foam and then restarts at the lower portion of the back foam by controlling the control valves to operate in the first manner for the first period of time.

In another aspect, the disclosure provides a vehicle seat that may include a frame, a back foam configured to provide a backrest, a plurality of adjustable pneumatic bladders positioned within the vehicle seat on an A-surface of the back foam, a source of pressurized air, and a plurality of control valves. Each control valve may be independently controllable to control whether the pressurized air is provided from the source to a respective bladder to allow for individual control of inflation of each bladder of the plurality of adjustable pneumatic bladders. The vehicle seat may also include an electronic processor coupled to the plurality of control valves to independently control each of the control valves. The electronic processor may be configured to control the plurality of control valves to operate in a first manner to inflate a first subgroup of bladders on the back foam for a first period of time. The first period of time may be at least two seconds. The first subgroup of bladders may include a right bladder and a left bladder. The electronic processor may also be configured to, in response to the first period of time elapsing, control the plurality of control valves to operate in a second manner to repeatedly, for a predetermined amount of repetitions and in an alternating manner, (i) inflate the left bladder and stop inflating the right bladder for a second period of time and (ii) stop inflating the left bladder and inflate the right bladder for a third period of time. The second period of time may be between and inclusive of 0.2 seconds and 0.3 seconds, and the third period of time may be between and inclusive of 0.2 seconds and 0.3 seconds. The electronic processor may also be configured to, in response to determining that the repeated control of the plurality of control valves in the alternating manner has repeated the predetermined amount of repetitions, control the plurality of control valves to operate in a third manner to inflate the first subgroup of bladders on the back foam for a fourth period of time. The fourth period of time may be at least one second. The electronic processor may be configured to control the plurality of control valves in the first manner, the second manner, and the third manner to provide a wave toggle or a step toggle starting on a first vertical portion of the back foam and moving in a direction up or down to a second vertical portion of the back foam. The electronic processor may be configured to control the plurality of control valves such that the wave toggle or the step toggle continues moving in the direction by controlling the control valves to inflate additional subgroups of bladders located in another vertical portion of the back foam.

In addition to any combination of features described above, the left bladder may include a first left low bladder and a second left low bladder that is above the first left low bladder in the back foam. In addition to any combination of features described above, the right bladder may include a first right low bladder and a second right low bladder that is above the first right low bladder in the back foam.

Other aspects of the disclosure will become apparent by consideration of the detailed description and accompanying drawings.

### BRIEF DESCRIPTION OF THE DRAWINGS

FIG. 1A illustrates a backrest portion of a vehicle seat, according to some example instances.

FIG. 1B illustrates the backrest portion of FIG. 1A with a back foam removed to allow a frame of the backrest portion 105 to be visible, according to some example instances.

FIG. 2A illustrates the backrest portion of FIG. 1A included on a vehicle seat as well as individual labels for each bladder of a plurality of pneumatic bladders included in the backrest portion of the vehicle seat, according to some example instances.

FIG. 2B illustrates a schematic diagram of pneumatic connections between each bladder included in the backrest portion of FIG. 2A and a respective control valve of a control device, according to some example instances.

FIG. 3 illustrates one of the bladders of FIGS. 1A-2B, according to some example instances.

FIG. 4 is a schematic block diagram of the vehicle seat of FIG. 2A, according to some example instances.

FIGS. 5A-5L illustrate a first method of controlling the bladders of the vehicle seat of FIG. 2A to implement a first massage pattern, according to some example instances.

FIGS. 6A-6L illustrate a second method of controlling the bladders of the vehicle seat of FIG. 2A to implement a second massage pattern, according to some example instances.

FIGS. 7A-7I illustrate a third method of controlling the bladders of the vehicle seat of FIG. 2A to implement a third massage pattern, according to some example instances.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software-based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology (e.g., “about,” “approximately,” “substantially,” etc.) may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

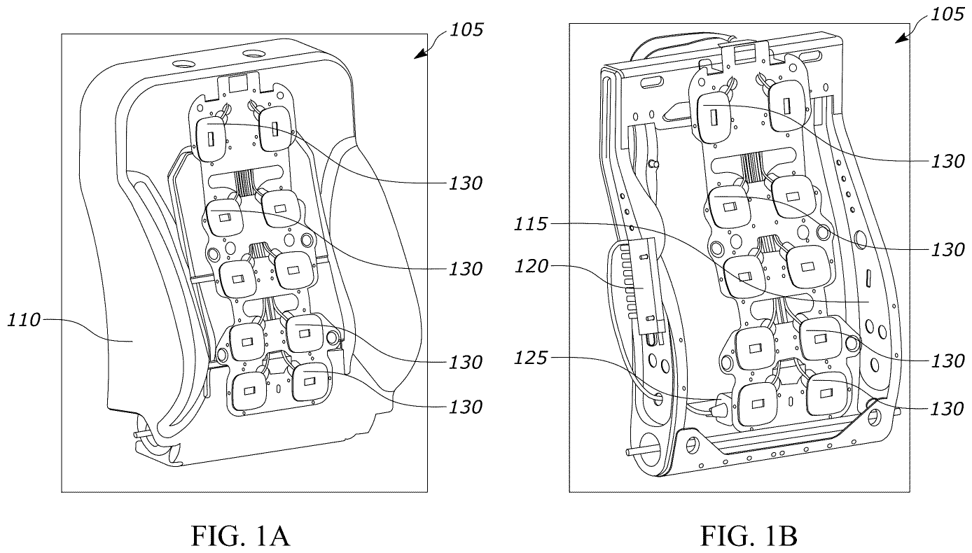

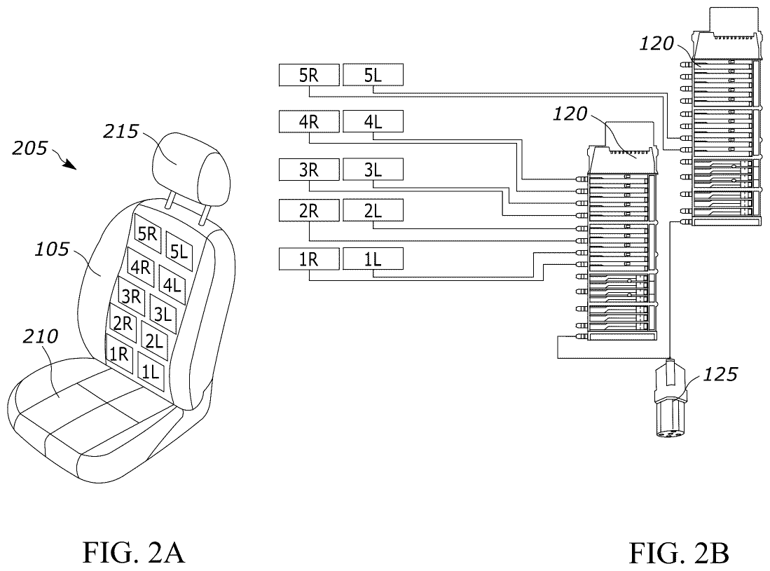

FIG. 1A illustrates a backrest portion 105 (i.e., back portion 105 or backrest 105) of a vehicle seat 205 (see FIG. 2A) according to some example instances. FIG. 1B illustrates the backrest portion 105 with a back foam 110 removed to allow a frame 115 of the backrest portion 105 to be visible. In some instances, the back foam 110 is configured to provide a backrest. In some instances, a control device 120 is mounted on the frame 115 underneath the back foam 110 as shown in FIG. 1B. The control device 120 may be referred to as an electronic control unit (ECU).

In some instances, the vehicle seat 205 also includes a source of pressurized air 125 mounted on the frame 115. For example, the source of pressurized air 125 may be a pneumatic pump 125 (e.g., a high flow pneumatic pump 125). In some instances, the pump 125 may include two high flow pneumatic pumps to provide adequate pressure for rapid inflation of one or more bladders 130. The pneumatic pump 125 may be coupled to the control device 120 to allow the control device 120 to independently control whether pressurized air from the pneumatic pump 125 is provided to each bladder 130 of a plurality of adjustable pneumatic bladders 130 positioned within the vehicle seat 205. For example, the control device 120 may include a plurality of control valves where each control valve is independently controllable to control whether the pressurized air is provided from the pump 125 to a respective bladder 130 to allow for individual control of inflation of each bladder 130 of the plurality of adjustable pneumatic bladders 130. As shown in FIG. 1B, one or more pneumatic hoses may couple the pump 125 to the control device 120. Additionally, individual pneumatic hoses may be routed between each control valve and a respective bladder 130.

As shown in FIGS. 1A and 1B, the bladders 130 may be positioned within the vehicle seat 205 on an A-surface of the back foam 110. An upper surface of the back foam 110 (closest to the occupant) may be referred to as the A-surface of the back foam 110, and a lower surface (closest to the frame 115) may be referred to as a B-surface of the back foam 110.

While the control device 120 and the pump 125 are shown as being mounted to the frame 115 of the backrest portion 105, in other instances, the control device 120 and/or the pump 125 may be mounted elsewhere within the seat 205 or outside of the seat 205. For example, one or both of the control device 120 and the pump 125 may be mounted within a seat base 210, underneath the seat 205, or elsewhere in a vehicle in which the seat 205 is located.

FIG. 2A illustrates the backrest portion 105 included on the seat 205 as well as individual labels for each of the bladders 130 included in the backrest portion 105, according to some example instances. FIG. 2B illustrates a schematic diagram of pneumatic connections between each bladder 130 and a respective control valve of the control device 120, according to some example instances.

As shown in FIG. 2A, the seat 205 includes the seat base 210, the backrest portion 105, and a head rest portion 215. The backrest portion 105 may include ten adjustable pneumatic bladders 130 arranged in five pairs of left and right bladders 130 from a lower portion of the backrest portion 105 near the seat base 210 to a higher portion of the backrest portion 105 near the head rest portion 215.

Although pairs of left and right bladders 130 are shown in FIGS. 2A and 2B, in some instances, additional or fewer bladders 130 may be included in each vertical portion/row (e.g., 1-5) of the backrest portion 105. For example, the backrest portion 105 may include two right (1R) bladders that may be controlled to operate together and two left (1L) bladders that may be controlled to operate together. As another example, the backrest portion 105 may include a single bladder 130 (e.g., that may be wider than the bladders 130 shown) in each vertical portion/row of the backrest portion 105. Although FIGS. 2A and 2B illustrate five vertical portions/rows of bladders 130 (e.g., 1-5) on the backrest portion 105, in some instances, the backrest portion 105 may include additional or fewer vertical portions/rows of bladders 130.

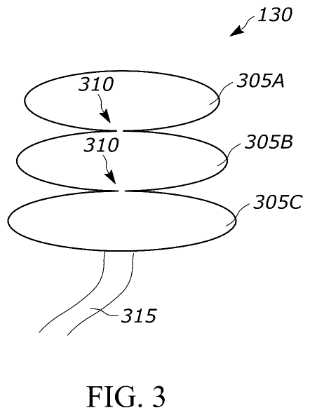

FIG. 3 illustrates one of the bladders 130 of FIGS. 1A-2B, according to some example instances. In some instances, each bladder 130 of the plurality of adjustable pneumatic bladders 130 includes a three-chamber bladder 130 with three chambers 305A, 305B, and 305C oriented in a stacked configuration. As shown in FIG. 3, an opening 310 may be present between each adjacent chamber 305 to allow air to circulate between chambers 305. A pneumatic hose 315 may be coupled to one of the chambers 305 to provide air from the pump 125 to the bladder 130 in response to a respective control valve associated with the bladder 130 being controlled to allow the flow of pressurized air from the pump to the bladder 130. In some instances, when the respective control valve is not allowing pressurized air from the pump 125 to flow to the bladder 130, the bladder 130 may deflate. In some of such instances, the bladder 130 may deflate in a passive manner, meaning that air is not pumped out of the bladder 130. Rather, pressurized air is merely no longer provided to the bladder 130, which allows the bladder 130 to deflate. In some instances, each bladder 130 is pneumatically independently connected to a single 3-port/2-position channel/control valve of the control device 120. In some instances, the control valves may include shape memory alloy (SMA) material to actuate their opening and/or closing based on temperature changes. In some instances, the control valves may be configured to change states (e.g., from an open position to a closed position or from a closed position to an open position) in approximately 0.2 seconds, approximately 0.25 seconds, approximately 0.3 seconds, or the like. In some instances, other types of control vales and/or bladders 130 may be used. In some instances, different types of bladders 130 (e.g., different shape and/or size) may be used for some bladders 130 than for other bladders 130 of the vehicle seat 205. In some instances, a number of chambers 305 in the stacked multi-chamber bladder 130 may be more or less than the number of chambers 305 shown in FIG. 3. For example, the number of chambers 305 may alternatively be two, four, five, or the like.

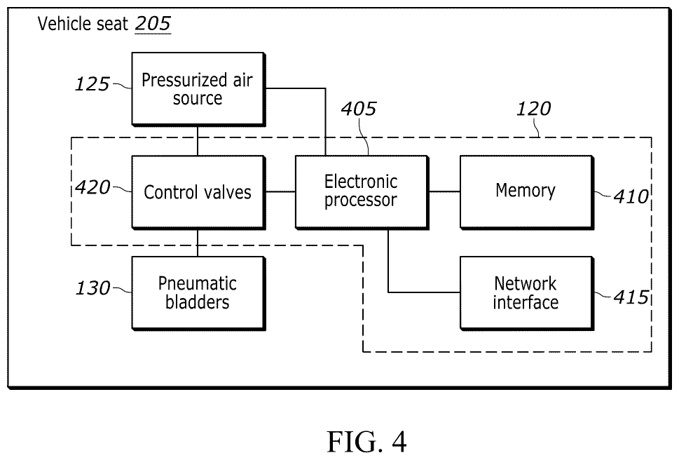

FIG. 4 is a schematic block diagram of the vehicle seat 205, according to some example instances. In the example illustrated in FIG. 4, the vehicle seat 205 includes an electronic processor 405 (for example, a microprocessor or other electronic device). The electronic processor 405 includes input and output interfaces (not shown) and is electrically coupled to a memory 410, a network interface 415, the pressurized air source 125 (e.g., one or more pumps 125), and the plurality of control valves 420 where each control valve is independently controllable to control whether the pressurized air is provided from the pressurized air source 125 to a respective bladder 130 to allow for individual control of inflation of each bladder 130 of the plurality of adjustable pneumatic bladders 130. In some instances, the vehicle seat 205 includes fewer or additional components in configurations different from that illustrated in FIG. 4 and/or optionally combines two or more components shown in FIG. 4. For example, the vehicle seat 205 may additionally include one or a combination of a display screen and a user input device such as one or more actuatable buttons. As another example, the vehicle seat 205 may not include the network interface 415 in some instances. As another example, the memory 410 may be combined with the electronic processor 405 in some instances.

As yet another example, the electronic processor 405 may include multiple electronic processors 405 within the vehicle seat 205 that together function to control various aspects of the vehicle seat 205. In some instances, the vehicle seat 205 is implemented within a distributed system including one or more components located in different devices that are within or external to the vehicle seat 205. For example, in some instances, the vehicle seat 205 (e.g., the electronic processor 405) includes local hardware components and one or more external hardware components (e.g., one or more electronic processors of the vehicle in which the vehicle seat 205 is located). In other words, the electronic processor 405 may include any one or a combination of electronic processors located within a single device (e.g., the vehicle seat 205) or distributed among various devices and/or systems. For example, the electronic processor 405 may include a first electronic processor 405 of the vehicle seat 205, a second electronic processor of the vehicle in which the vehicle seat 205 is located that is configured to communicate with the vehicle seat 205 (i.e., the first electronic processor 405), or both the first electronic processor 405 and the second electronic processor. Thus, in the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make some or all of the multiple determinations. To reiterate, those electronic processors and processing may be distributed within a single device or across multiple devices.

Similarly and as described previously herein, the pressurized air source 125 and/or the control device 120 that includes the control valves 420 may be located within the vehicle seat 205, underneath the vehicle seat 205, external to the vehicle seat 205 at a different location in the vehicle in which the vehicle seat 205 is located, or a combination thereof. In some instances, the control device 120 (i.e., ECU) includes a housing that houses the control valves 420, the electronic processor 405, the memory 410, the network interface 415, or combinations thereof as indicated schematically by dashed lines in FIG. 4.

In some instances, the vehicle seat 205 performs functionality other than the functionality described below. The various components of the vehicle seat 205 described herein are implemented in hardware, software, or a combination of both hardware and software, including one or more signal processing and/or application-specific integrated circuits.

The memory 410 may include read only memory (ROM), random access memory (RAM), other non-transitory computer-readable media, or a combination thereof. The electronic processor 405 is configured to receive instructions and data from the memory 410 and execute, among other things, the instructions. In particular, the electronic processor 405 executes instructions stored in the memory 410 to perform the methods (e.g., implement the massage patterns/sequences) described herein.

The network interface 415 sends data to and receives data from other devices (e.g., an external device such as a smart phone) that may be used to communicate with the electronic processor 405 to program the electronic processor 405 and/or the memory 410 to include the massage patterns/sequences described herein. In some instances, the network interface 415 includes one or more transceivers for wirelessly communicating with the other devices. Alternatively or in addition, the network interface 415 may include a connector or port for receiving a wired connection to one or more of the other devices, such as connector to receive a coaxial cable. The electronic processor 405 may receive data (for example, massage patterns and/or the like) from one or more other devices (e.g., a smart phone and/or another device) via the network interface 415. The electronic processor 405 may output data (e.g., an acknowledgement of receipt of massage patterns) to the external device via the network interface 415.

In some instances, the vehicle seat 205 may receive power from another device (e.g., the vehicle where the vehicle seat 205 is located) to power components of the vehicle seat 205 (e.g., the electronic processor 405). In some instances, the vehicle seat 205 may include a separate power connection to receive power from another device and/or may include its own power supply such as a rechargeable or replaceable battery.

In some instances, the electronic processor 405 is coupled to the plurality of control valves 420 to independently control each of the control valves 420. For example, each control valve 420 is coupled between the pressurized air source 125 and a respective bladder 130 as explained previously herein. The electronic processor 405 may be configured to individually control each control valve 420 to inflate a respective bladder 130 (i.e., provide the pressurized air to the respective bladder 130) or to stop inflating the respective bladder 130 (i.e., stop providing the pressurized air to the respective bladder 130). As explained previously herein, when the pressurized air is not provided to the respective bladder 130, the respective bladder 130 may passively deflate (i.e., without active air suction out of the respective bladder 130) via its respective control valve 420. As explained previously herein, each control valve 420 may be a single 3-port/2-position channel/control valve. In some instances, each control valve 420 may include shape memory alloy (SMA) material to actuate its opening and/or closing based on temperature changes (e.g., caused by the presence or absence of current through the SMA material).

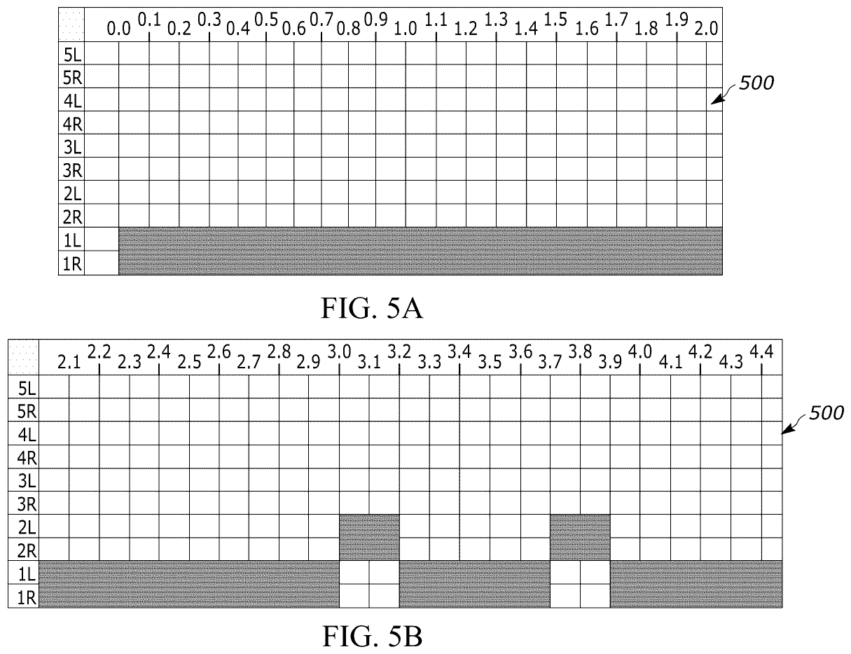

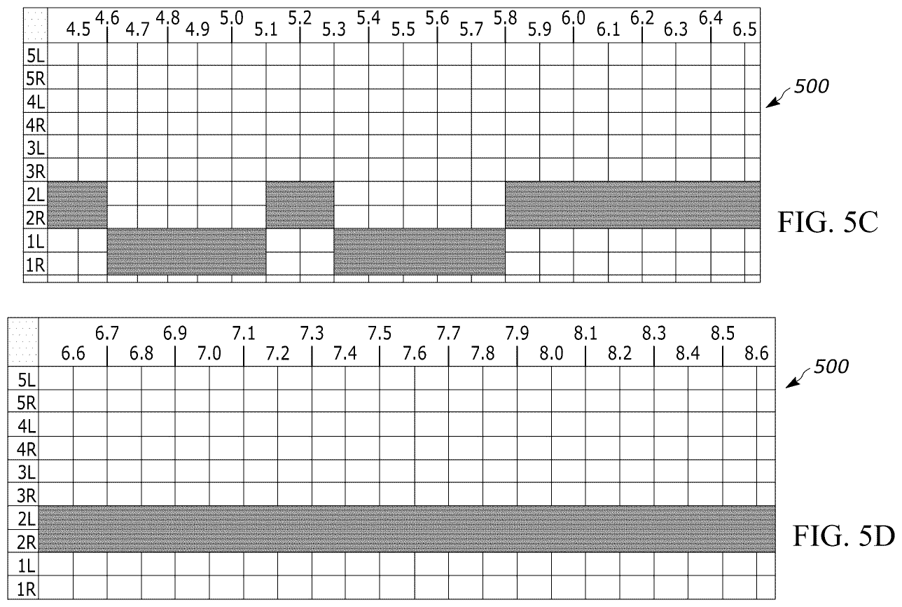

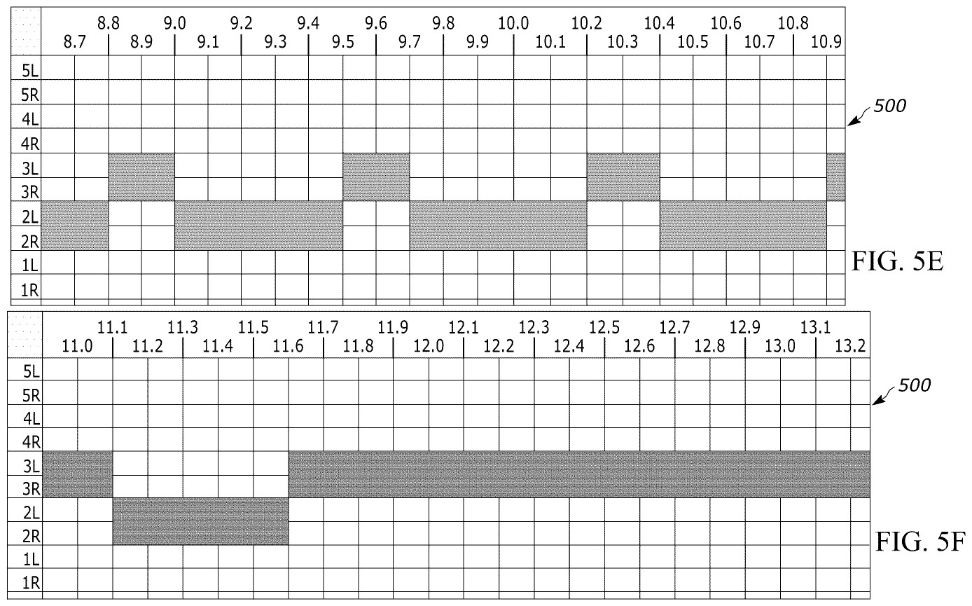

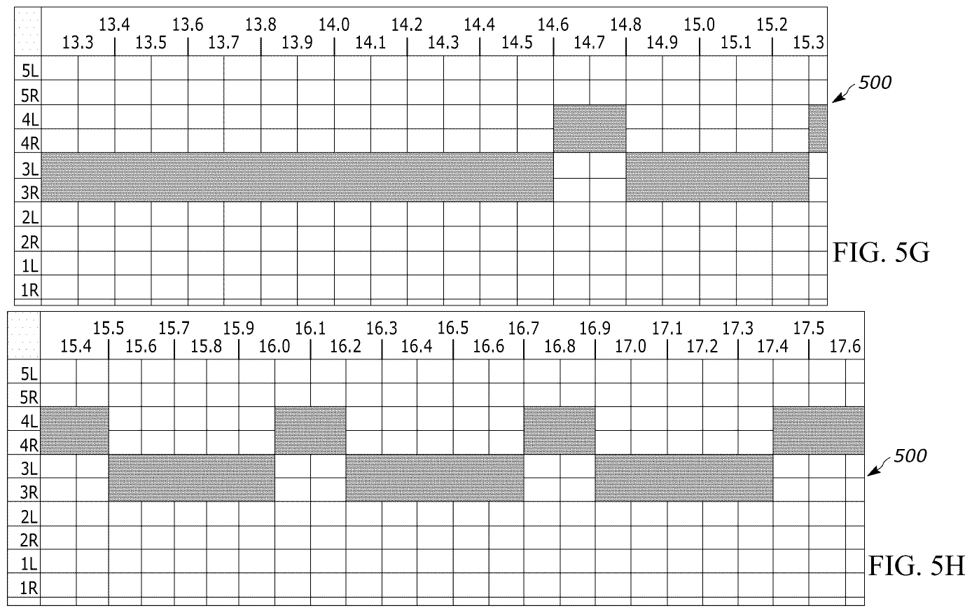

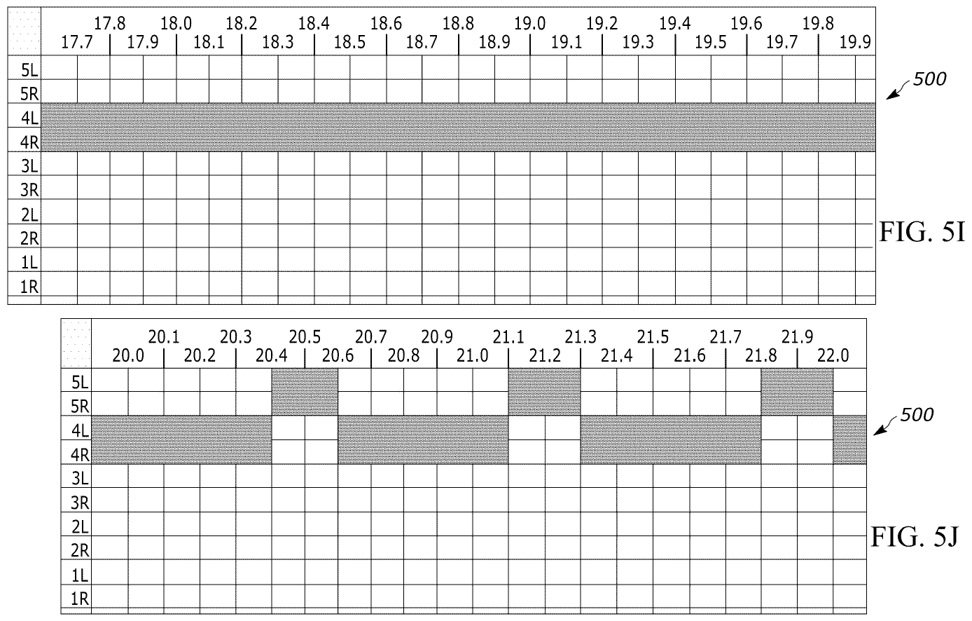

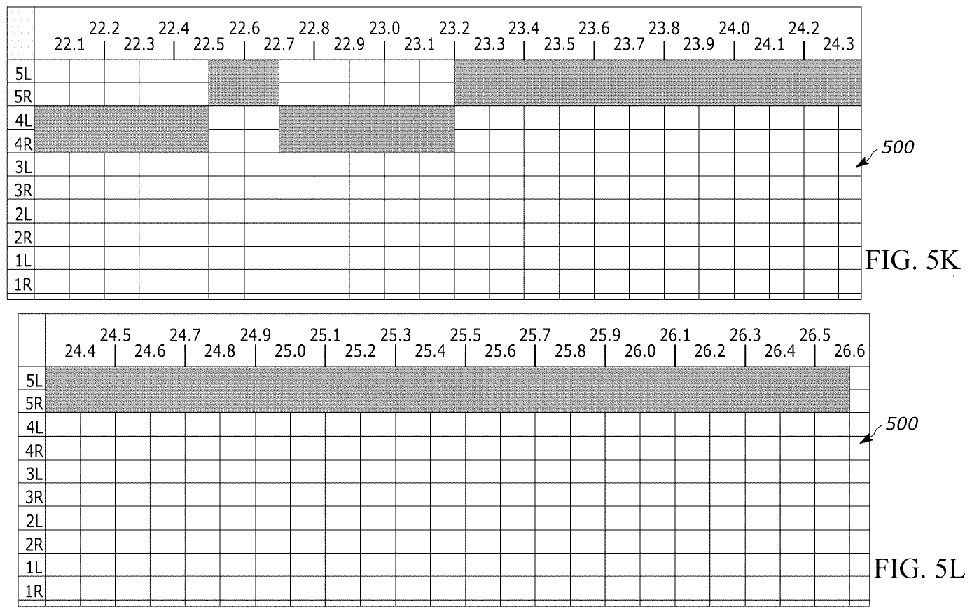

FIGS. 5A-5L, 6A-6L, and 7A-7I illustrate three different methods of controlling the bladders 130 to implement respective massage patterns, according to some example instances. In these figures, a y-axis is labeled with the individual labels of each bladder 130 of the backrest portion 105 shown in FIGS. 2A and 2B. An x-axis indicates time and is labeled every 0.1 seconds. The solid cells shown in these figures indicate that the control valve 420 of the respective bladder 130 is being controlled to inflate the respective bladder 130 (i.e., allow pressurized air to be provided to the respective bladder 130). On the other hand, the empty cells shown in these figures indicate that the control valve of the respective bladder 130 is being controlled to not allow pressurized air to be provided to the respective bladder 130. Accordingly, the solid cells may be referred to as corresponding bladders 130 inflating while the empty cells may be referred to as corresponding bladders 130 deflating (e.g., passively deflating).

In some instances, implementing the massage patterns of FIGS. 5A-5L, 6A-6L, and 7A-7I using the high-pressure air source 125 and control valves 420 that are configured for rapid inflation and/or deflation provides more intensity and/or a pulsing sensation to an occupant, which results in an improved/enhanced massage experience. For example, by controlling the control valves 420 that control the flow of fluid (e.g., air) to one or more bladders 130 to be rapidly opened and/or closed (e.g., in about and/or less than one second, in about and/or less than 0.5 seconds, in about and/or less than 0.25 seconds, and/or the like) for at least a portion of a massage sequence/pattern, the vehicle seat 205 may provide a more intense and/or unique massage/comfort experience to the occupant.

FIGS. 5A-5L illustrate a first method of controlling the bladders 130 to implement a first massage pattern 500, according to some example instances. The first massage pattern 500 may be referred to as a wave pulse pattern (e.g., a three second wave pulse) in some instances.

As shown in FIGS. 5A and 5B, in some instances, the electronic processor 405 is configured to control the plurality of control valves 420 to operate in a first manner to inflate a first bladder 130 (e.g., bladder 1L and/or 1R) on the back foam 110 for a first period of time. In the example shown in FIGS. 5A and 5B, the first period of time is three seconds. In some instances, the first period of time is between and inclusive of 2.5 seconds and 3.5 seconds. In some instances, the first period of time is an alternative value or within an alternate range.

In some instances, in response to the first period of time elapsing, the electronic processor 405 is configured to control, for a second period of time that is shorter than the first period of time, the plurality of control valves 420 to operate in a second manner to stop inflating the first bladder 130 (e.g., bladder 1L and/or 1R) and inflate a first vertically adjacent bladder 130 (e.g., bladder 2L and/or 2R) that is vertically adjacent to the first bladder on the back foam 110. In the example shown in FIG. 5B, the second period of time is 0.2 seconds. In some instances, the second period of time is between and inclusive of 0.2 seconds and 0.3 seconds, for example, to provide a rapid inflation of the bladder 130 and pulsing sensation to the occupant. In some instances, the second period of time is an alternative value or within an alternate range.

In some instances, in response to the second period of time elapsing, the electronic processor 405 is configured to control, for a third period of time that is shorter than the first period of time and longer than the second period of time, the plurality of control valves 420 to operate in a third manner to stop inflating the first vertically adjacent bladder 130 (e.g., bladder 2L and/or 2R) and inflate the first bladder 130 (e.g., bladder 1L and/or 1R). In the example shown in FIG. 5B, the third period of time is 0.5 seconds. In some instances, the third period of time is between and inclusive of 0.45 second and 0.55 seconds, for example, to provide a rapid inflation of the bladder 130 and pulsing sensation to the occupant. In some instances, the third period of time is an alternative value or within an alternate range.

In some instances, the electronic processor 405 is configured to repeatedly control the plurality of control valves 420 to operate in the second manner for the second period of time and in the third manner for the third period of time in an alternating manner for a predetermined amount of repetitions. In the example shown in FIGS. 5B and 5C, the predetermined amount of repetitions is three additional repetitions or four total instances. In some instances, the predetermined amount of repetitions is between and inclusive of two and six.

In some instances, in response to determining that the repeated control of the plurality of control valves 420 in the alternating manner has repeated the predetermined amount of repetitions, the electronic processor 405 is configured to control the plurality of control valves to operate in a fourth manner to inflate the first vertically adjacent bladder (e.g., bladder 2L and/or 2R) and to stop inflating the first bladder (e.g., bladder 1L and/or 1R) for a fourth period of time. In the example shown in FIGS. 5C-5E, the fourth period of time is three seconds. In some instances, the fourth period of time is between and inclusive of 2.5 seconds and 3.5 seconds. In some instances, the fourth period of time is an alternative value or within an alternate range. In some instances, the first period of time is the same as the fourth period of time.

In some instances, in response to the fourth period of time elapsing, the electronic processor 405 is configured to control, for the second period of time, the plurality of control valves 420 to operate in a fifth manner to stop inflating the first vertically adjacent bladder (e.g., bladder 2L and/or 2R) and inflate a second vertically adjacent bladder (e.g., bladder 3L and/or 3R) that is vertically adjacent to the first vertically adjacent bladder (e.g., bladder 2L and/or 2R) on the back foam 110. In some instances, the first vertically adjacent bladder (e.g., bladder 2L and/or 2R) is located vertically between the first bladder (e.g., bladder 1L and/or 1R) and the second vertically adjacent bladder (e.g., bladder 3L and/or 3R) on the back foam 110. As indicated previously herein, in the example illustrated in FIG. 5E, the second time period may be 0.2 seconds.

In some instances, in response to the second period of time elapsing, the electronic processor 405 may be configured to control, for the third period of time, the plurality of control valves 420 to operate in a sixth manner to stop inflating the second vertically adjacent bladder (e.g., bladder 3L and/or 3R) and inflate the first vertically adjacent bladder (e.g., bladder 2L and/or 2R). As indicated previously herein, in the example illustrated in FIG. 5E, the second time period may be 0.5 seconds.

In some instances, the electronic processor 405 may be configured to repeatedly control the plurality of control valves 420 to operate in the fifth manner for the second period of time and in the sixth manner for the third period of time in the alternating manner for the predetermined amount of repetitions. As indicated previously herein, in the example shown in FIGS. 5E and 5F, the predetermined amount of repetitions is three additional repetitions or four total instances.

The massage pattern 500 continues to provide massaging output up the backrest portion 105 of the vehicle seat 205 as explained below. For example, the electronic processor 405 is configured to control the plurality of control valves 420 in the first manner, the second manner, the third manner, the fourth manner, the fifth manner, and the sixth manner to provide a wave pulse starting on a lower portion of the back foam 110 and moving upwards to a middle portion of the back foam 110. The electronic processor also may be configured to control the plurality of control valves 420 such that the wave pulse continues upward to a higher portion of the back foam 110 and then restarts at the lower portion of the back foam 110 by controlling the control valves 420 to operate in the first manner for the first period of time.

As shown in FIGS. 5A and 5B, during implementation of the massage pattern 500, both bladders 1L and 1R in the lowest vertical portion/row may be inflated for three seconds while none of the other bladders 2R-5R and 2L-5L are inflated. As shown in FIG. 5B, at the three second mark, inflation of bladders 1L and 1R may stop for 0.2 seconds, and bladders 2R and 2L may be inflated for the same 0.2 seconds. Also as shown in FIG. 5B, at the 3.2 second mark, inflation of bladders 2R and 2L may stop for 0.5 seconds, and bladders 1R and 1L may be inflated for the same 0.5 seconds. The 0.2 second time period and 0.5 second time period may consecutively repeat for a predetermined number of repetitions (e.g., three more repetitions or four total instances of the 0.2 second time period and the 0.5 second time period) as shown in FIGS. 5B and 5C.

Accordingly, the first 5.8 seconds of the pattern 500 (e.g., approximately 6 seconds) make up a first control cycle that includes inflation of bladders 1L, 1R, 2L, and 2R at certain time periods. At the 5.9 second mark, a second control cycle begins that is similar to the first control cycle but that includes inflation of bladders 2L, 2R, 3L, and 3R at certain time periods to gradually move massaging output up the backrest portion 105 of the vehicle seat 205. For example, during the second control cycle from the 5.9 second mark to the 11.6 second mark, bladders 2L and 2R are controlled similarly to how the bladders 1L and 1R were controlled during the first control cycle, and bladders 3L and 3R are controlled similarly to how bladders 2L and 2R were controlled during the first control cycle. Additional control cycles are implemented until the top vertical portion/row of bladders 5L and 5R implement a control cycle. After such implementation, the massage pattern 500 may repeat by again implementing the first control cycle.

As indicated by the above explanation of the massage pattern 500 shown in FIGS. 5A-5L, each of the first bladder 130, the first vertically adjacent bladder 130, and the second vertically adjacent bladder 130 may include a left bladder and a right bladder. In other instances, the massage pattern 500 may be implemented using a single vertical column of bladders 130 (e.g., just the left bladders, just the right bladders, a single column of larger bladders, or the like). In other instances, each of the first bladder 130, the first vertically adjacent bladder 130, and the second vertically adjacent bladder 130 may include additional bladders 130 (e.g., a third, fourth, etc. bladder located in the respective vertical portion/row of the backrest portion 105).

Also as indicated by the above explanation of the massage pattern 500, the first vertically adjacent bladder 130 (e.g., bladder 2L and/or 2R) includes a first next highest bladder (e.g., bladder 2L and/or 2R) above the first bladder (e.g., bladder 1L and/or 1R), and the second vertically adjacent bladder (e.g., bladder 3L and/or 3R) includes a second next highest bladder (e.g., bladder 3L and/or 3R) above the first next highest bladder (e.g., bladder 2L and/or 2R). In other words, the massage pattern 500 moves up the backrest portion 105. In other instances, the vertically adjacent bladders 130 may be vertically adjacent in a downward direction to cause the massage pattern 500 to move down the backrest portion 105.

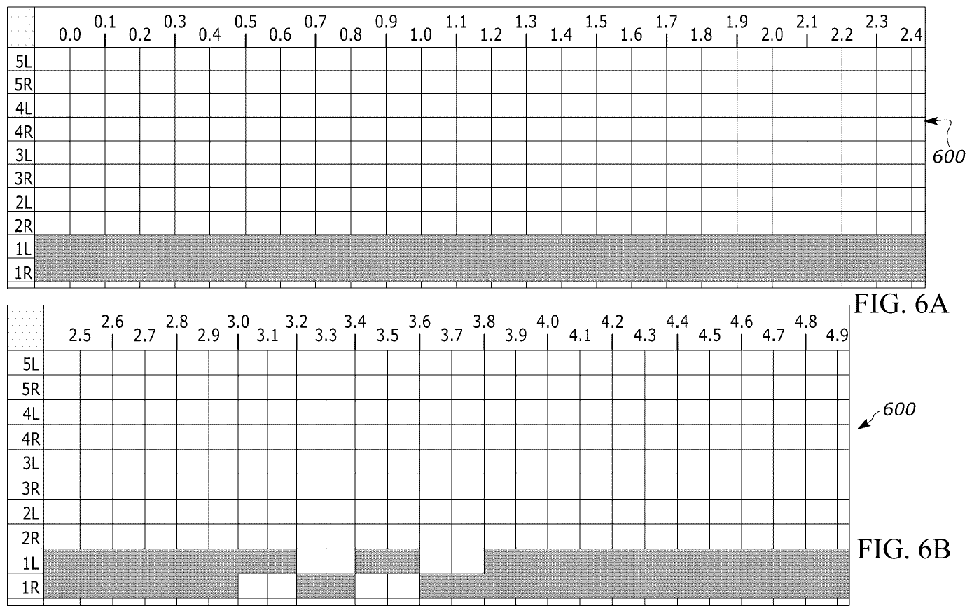

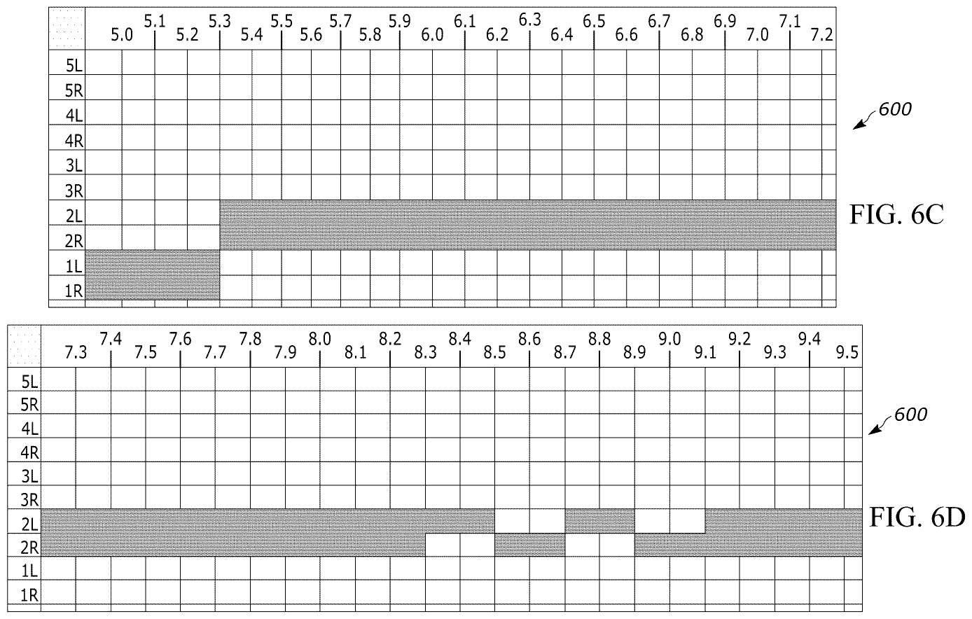

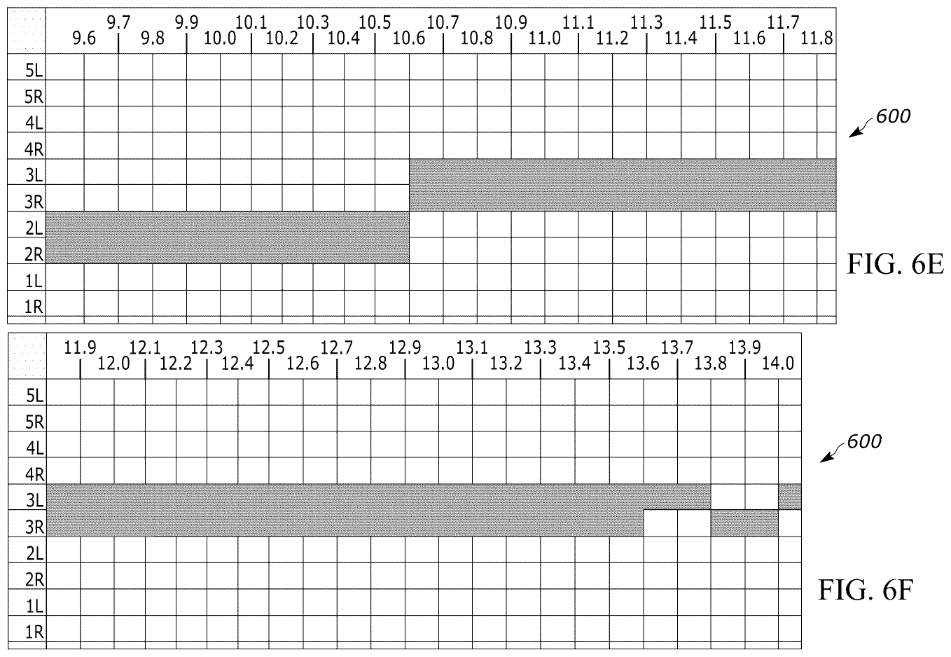

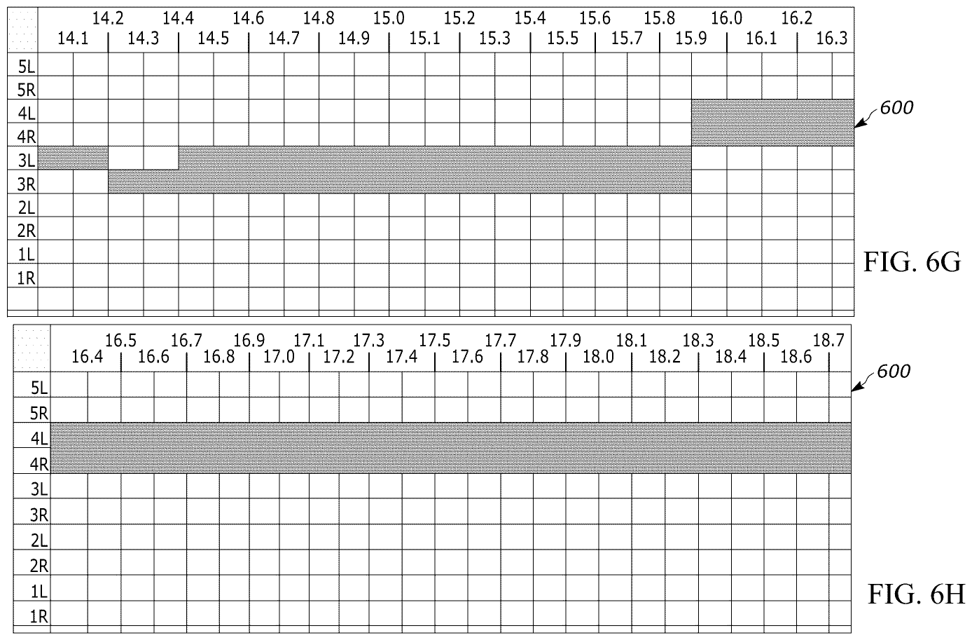

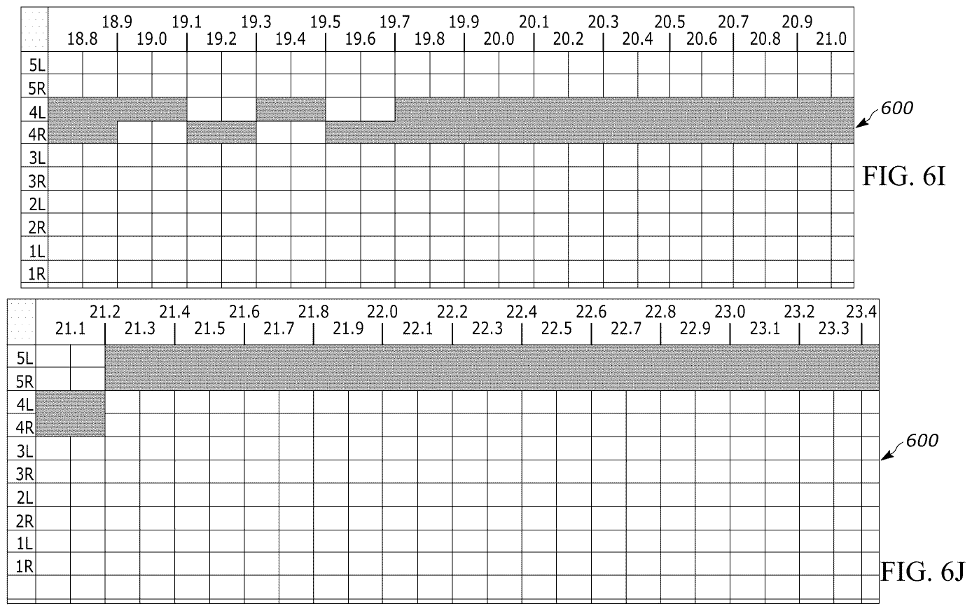

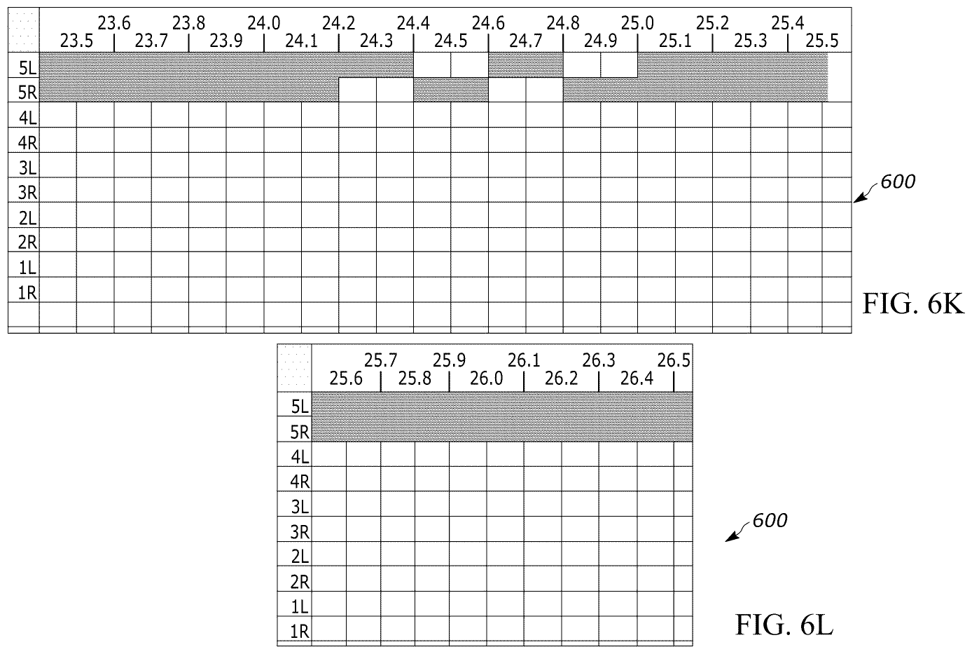

FIGS. 6A-6L illustrate a second method of controlling the bladders 130 to implement a second massage pattern 600, according to some example instances. The second massage pattern 600 may be referred to as a wave toggle pattern (e.g., a three second wave toggle) in some instances.

As shown in FIGS. 6A and 6B, in some instances, the electronic processor 405 is configured to control the plurality of control valves 420 to operate in a first manner to inflate a left first bladder 1L and a right first bladder 1R on the back foam 110 for a first period of time. In the example shown in FIGS. 6A and 6B, the first period of time is three seconds. In some instances, the first period of time is between and inclusive of 2.5 seconds and 3.0 seconds. In some instances, the first period of time is an alternative value or within an alternate range.

In some instances, in response to the first period of time elapsing, the electronic processor 405 is configured to control, for a second period of time that is shorter than the first period of time, the plurality of control valves 420 to operate in a second manner to stop inflating one of the left first bladder 1L and the right first bladder 1R while continuing to inflate the other of the left first bladder 1L and the right first bladder 1R. In the example shown in FIG. 6B, the second period of time is 0.2 seconds. In some instances, the second period of time is between and inclusive of 0.2 seconds and 0.3 seconds, for example, to provide a rapid inflation of the bladder 130 and pulsing sensation to the occupant. In some instances, the second period of time is an alternative value or within an alternate range.

In some instances, in response to the second period of time elapsing, the electronic processor 405 is configured to control, for the second period of time, the plurality of control valves 420 to operate in a third manner to stop inflating the other of the left first bladder 1L and the right first bladder 1R and inflate the one of the left first bladder 1L and the right first bladder 1R.

In some instances, the electronic processor 405 is configured to repeatedly control the plurality of control valves 420 to operate in the second manner for the second period of time and in the third manner for the second period of time in an alternating manner for a predetermined amount of repetitions. In the example shown in FIG. 6B, the predetermined amount of repetitions is one additional repetition or two total instances. In some instances, the predetermined amount of repetitions is between and inclusive of one and four.

In some instances, in response to determining that the repeated control of the plurality of control valves 420 in the alternating manner has repeated the predetermined amount of repetitions, the electronic processor 405 is configured to control the plurality of control valves 420 to operate in the first manner for a third period of time that is shorter than the first period of time and longer than the second period of time. In the example shown in FIGS. 6B and 6C, the third period of time is 1.5 seconds. In some instances, the third period of time is between and inclusive of 1.0 seconds and 1.5 seconds. In some instances, the third period of time is an alternative value or within an alternate range.

In some instances, in response to the third period of time elapsing, the electronic processor 405 is configured to control, for a fourth period of time, the plurality of control valves 420 to operate in a fourth manner to inflate a left vertically adjacent bladder 2L that is vertically adjacent to the left first bladder 1L and a right vertically adjacent bladder 2R that is vertically adjacent to the right first bladder 1R on the back foam 110 and to stop inflating the left first bladder 1L and the right first bladder 1R. In the example shown in FIGS. 6C-6D, the fourth period of time is three seconds. In some instances, the fourth period of time is between and inclusive of 2.5 seconds and 3.0 seconds. In some instances, the fourth period of time is an alternative value or within an alternate range. In some instances, the first period of time is the same as the fourth period of time.

In some instances, in response to the fourth period of time elapsing, the electronic processor 405 is configured to control, for the second period of time, the plurality of control valves 420 to operate in a fifth manner to stop inflating one of the left vertically adjacent bladder 2L and the right vertically adjacent bladder 2R while continuing to inflate the other of the left vertically adjacent bladder 2L and the right vertically adjacent bladder 2R. As indicated previously herein, in the example illustrated in FIG. 6D, the second time period may be 0.2 seconds.

In some instances, in response to the second period of time elapsing, the electronic processor 405 is configured to control, for the second period of time, the plurality of control valves 420 to operate in a sixth manner to stop inflating the other of the left vertically adjacent bladder 2L and the right vertically adjacent bladder 2R and inflate the one of the left vertically adjacent bladder 1L and the right vertically adjacent bladder 1R.

In some instances, the electronic processor 405 is configured to repeatedly control the plurality of control valves 420 to operate in the fifth manner for the second period of time and in the sixth manner for the second period of time in the alternating manner for the predetermined amount of repetitions.

In some instances, in response to determining that the repeated control of the plurality of control valves 420 in the alternating manner has repeated the predetermined amount of repetitions, the electronic processor 405 is configured to control the plurality of control valves 420 to operate in the fourth manner for a fifth period of time that is shorter than the fourth period of time and longer than the second period of time. In the example shown in FIGS. 6D and 6E, the fifth period of time is 1.5 seconds. In some instances, the fifth period of time is between and inclusive of 1.0 seconds and 1.5 seconds. In some instances, the fifth period of time is an alternative value or within an alternate range. In some instances, the third period of time is the same as the fifth period of time.

The massage pattern 600 continues to provide massaging output up the backrest portion 105 of the vehicle seat 205 as explained below. For example, the electronic processor 405 is configured to control the plurality of control valves 420 in the first manner, the second manner, the third manner, the fourth manner, the fifth manner, and the sixth manner to provide a wave toggle starting on a lower portion of the back foam 110 and moving upwards to a middle portion of the back foam 110. The electronic processor 405 also may be configured to control the plurality of control valves 420 such that the wave toggle continues upward to a higher portion of the back foam 110 and then restarts at the lower portion of the back foam 110 by controlling the control valves 420 to operate in the first manner for the first period of time.

As shown in FIGS. 6A and 6B, during implementation of the massage pattern 600, both bladders 1L and 1R in the lowest vertical portion/row may be inflated for three seconds while none of the other bladders 2R-5R and 2L-5L are inflated. As shown in FIG. 6B, at the three second mark, inflation of one of bladders 1L and 1R may stop for 0.2 seconds while inflation of the other bladder of 1L and 1R continues for the same 0.2 seconds. Also as shown in FIG. 6B, at the 3.2 second mark, the inflation of bladders 1L and 1R switches/reverses such that the other bladder of 1L and 1R is stopped for 0.2 seconds and the one of the bladders 1L and 1R is inflated for the same 0.2 seconds. These two consecutive 0.2 second time periods may consecutively repeat for a predetermined number of repetitions (e.g., one more repetition or two total instances of the two 0.2 second time periods) as shown in FIG. 6B. After the predetermined number of repetitions, at the 3.9 second mark, both bladders 1L and 1R may be inflated for 1.5 seconds until the 5.3 second mark.

Accordingly, the first 5.3 seconds of the pattern 600 make up a first control cycle that includes inflation of bladders 1L and 1R at certain time periods. At the 5.4 second mark, a second control cycle begins that is similar to the first control cycle but that includes inflation of bladders 2L and 2R at certain time periods to gradually move massaging output up the backrest portion 105 of the vehicle seat 205. For example, during the second control cycle from the 5.4 second mark to the 10.6 second mark, bladders 2L and 2R are controlled similarly to how the bladders 1L and 1R were controlled during the first control cycle. Additional control cycles are implemented until the top vertical portion/row of bladders 5L and 5R implement a control cycle. After such implementation, the massage pattern 600 may repeat by again implementing the first control cycle at the lowest vertical portion/row of the backrest portion 105.

As indicated by the above explanation of the massage pattern 600 shown in FIGS. 6A-6L, the left vertically adjacent bladder 2L includes a left next highest bladder 2L above the left first bladder 1L, and the right vertically adjacent bladder 2R includes a right next highest bladder 2R above the right first bladder 1R. In other words, the massage pattern 600 moves up the backrest portion 105. In other instances, the vertically adjacent bladders 130 may be vertically adjacent in a downward direction to cause the massage pattern 600 to move down the backrest portion 105. Additionally, in some instances, each of the left vertically adjacent bladder 2L, the right vertically adjacent bladder 2R, the left first bladder 1L, and the right first bladder 1R may include additional bladders 130 (e.g., a second, third, etc. bladder located in the respective vertical portion/row of the backrest portion 105) instead of a single right bladder 130 and a single left bladder 130.

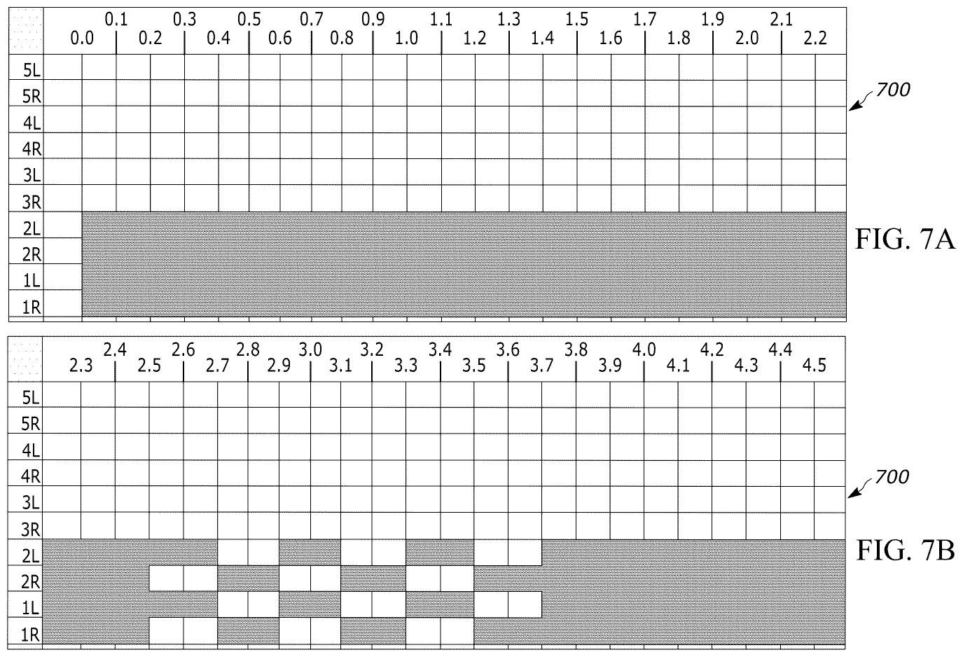

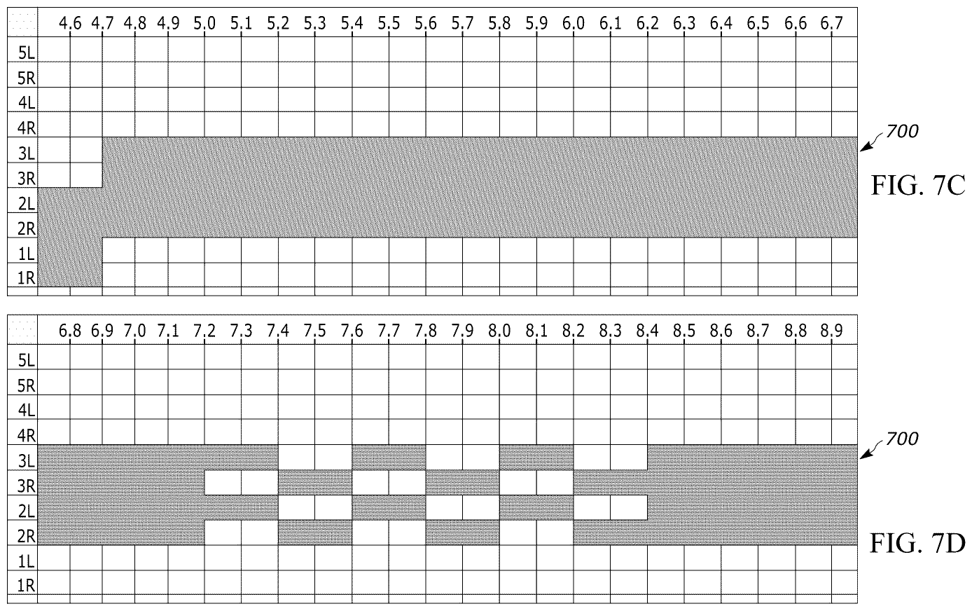

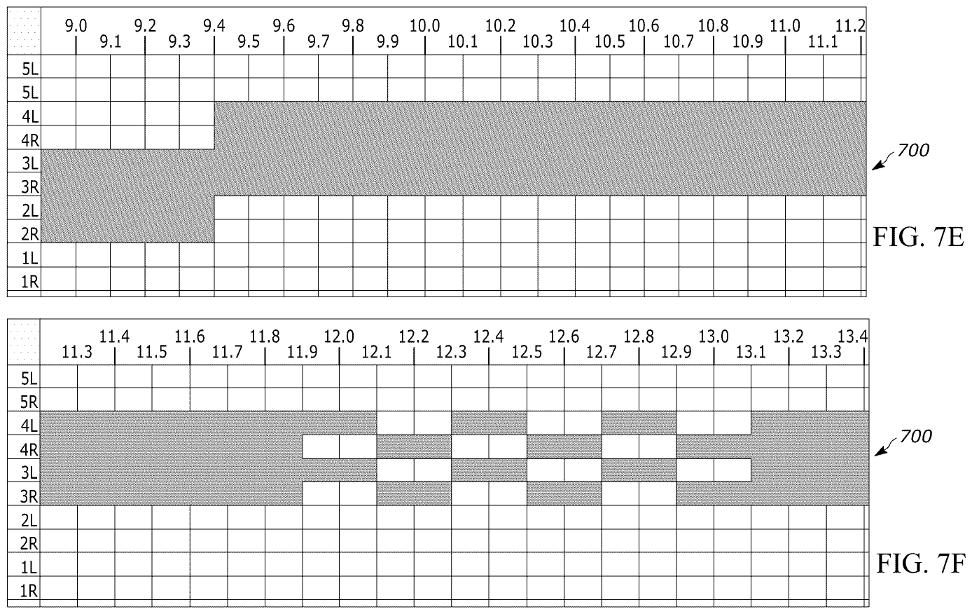

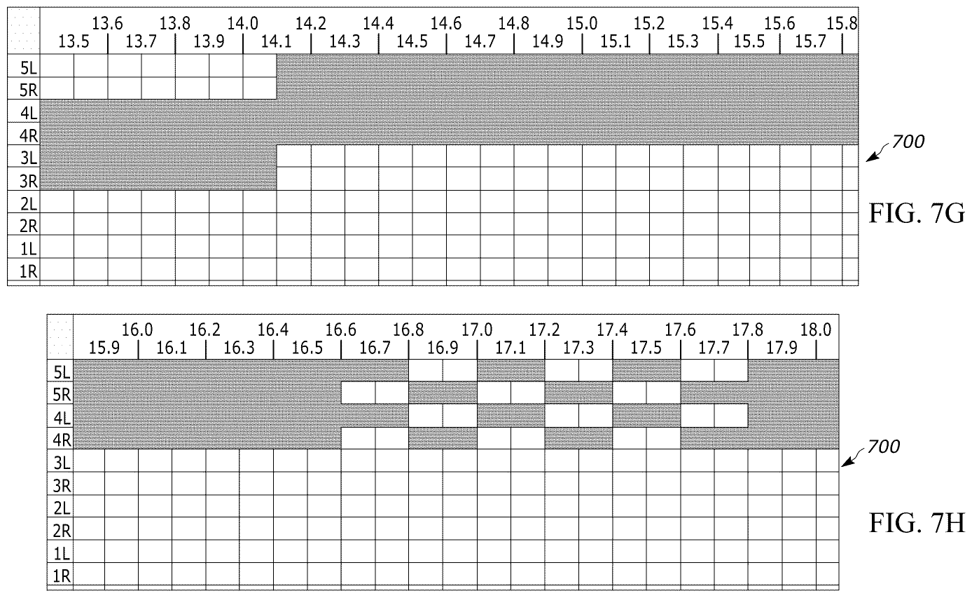

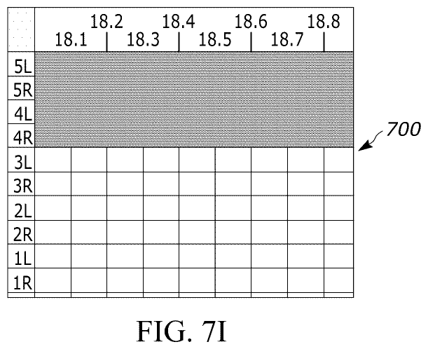

FIGS. 7A-7I illustrate a third method of controlling the bladders 130 to implement a third massage pattern 700, according to some example instances. The third massage pattern 700 may be referred to as a step toggle pattern (e.g., a two second step toggle) in some instances.

As shown in FIGS. 7A and 7B, in some instances, in some instances, the electronic processor 405 is configured to control the plurality of control valves 420 to operate in a first manner to inflate a left first bladder 130 (e.g., two left first bladders 1L and 2L) and a right first bladder 130 (e.g., two right first bladders 1R and 2R) on the back foam 110 for a first period of time. In the example shown in FIGS. 7A and 7B, the first period of time is 2.5 seconds. In some instances, the first period of time is between and inclusive of 2.5 seconds and 3.0 seconds. In some instances, the first period of time is an alternative value or within an alternate range.

In some instances, in response to the first period of time elapsing, the electronic processor 405 is configured to control, for a second period of time that is shorter than the first period of time, the plurality of control valves 420 to operate in a second manner to stop inflating one of the left first bladder 130 (e.g., bladders 1L and 2L) and the right first bladder 130 (e.g., bladders 1R and 2R) while continuing to inflate the other of the left first bladder 130 and the right first bladder 130. In the example shown in FIG. 7B, the second period of time is 0.2 seconds. In some instances, the second period of time is between and inclusive of 0.2 seconds and 0.3 seconds, for example, to provide a rapid inflation of the bladder 130 and pulsing sensation to the occupant. In some instances, the second period of time is an alternative value or within an alternate range.

In some instances, in response to the second period of time elapsing, the electronic processor 405 is configured to control, for the second period of time, the plurality of control valves 420 to operate in a third manner to stop inflating the other of the left first bladder 130 (e.g., bladders 1L and 2L) and the right first bladder 130 (e.g., bladders 1R and 2R) and inflate the one of the left first bladder 130 and the right first bladder 130.

In some instances, the electronic processor 405 is configured to repeatedly control the plurality of control valves 420 to operate in the second manner for the second period of time and in the third manner for the second period of time in an alternating manner for a predetermined amount of repetitions. In the example shown in FIG. 7B, the predetermined amount of repetitions is two additional repetitions or three total instances. In some instances, the predetermined amount of repetitions is between and inclusive of one and four. In some instances, the second manner and the third manner of operation of the massage pattern 700 is similar to the second manner and the third manner of operation of the massage pattern 600 except that two vertical portions/rows of bladders 130 (e.g., 1L, 2L and 1R, 2R) are inflated at certain times instead of a single vertical portion/row of bladders 130 (e.g., 1L and 1R) being inflated at certain times in accordance with the massage pattern 600.

In some instances, in response to determining that the repeated control of the plurality of control valves 420 in the alternating manner has repeated the predetermined amount of repetitions, the electronic processor 405 is configured to control the plurality of control valves 420 to operate in the first manner for a third period of time that is shorter than the first period of time and longer than the second period of time. In the example shown in FIGS. 7B and 7C, the third period of time is one second. In some instances, the third period of time is between and inclusive of 1.0 seconds and 1.5 seconds. In some instances, the third period of time is an alternative value or within an alternate range.

In some instances, in response to the third period of time elapsing, the electronic processor 405 is configured to control, for a fourth period of time, the plurality of control valves 420 to operate in a fourth manner to inflate a left vertically adjacent bladder 130 (e.g., bladders 2L and 3L) that is (at least partially) vertically adjacent to the left first bladder 130 (e.g., bladders 1L and 2L) and a right vertically adjacent bladder 130 (e.g., bladders 2R and 3R) that is (at least partially) vertically adjacent to the right first bladder 130 (e.g., bladders 1R and 2R) on the back foam 110 and to stop inflating the left first bladder 130 (e.g., bladder 1L) and the right first bladder 130 (e.g., bladder 1R). In the example shown in FIGS. 7C-7D, the fourth period of time is 2.5 seconds. In some instances, the fourth period of time is between and inclusive of 2.5 seconds and 3.0 seconds. In some instances, the fourth period of time is an alternative value or within an alternate range. In some instances, the first period of time is the same as the fourth period of time.

In some instances, in response to the fourth period of time elapsing, the electronic processor 405 is configured to control, for the second period of time, the plurality of control valves 420 to operate in a fifth manner to stop inflating one of the left vertically adjacent bladder 130 (e.g., bladders 2L and 3L) and the right vertically adjacent bladder 130 (e.g., bladders 2R and 3R) while continuing to inflate the other of the left vertically adjacent bladder 130 and the right vertically adjacent bladder 130. As indicated previously herein, in the example illustrated in FIG. 7D, the second time period may be 0.2 seconds.

In some instances, in response to the second period of time elapsing, the electronic processor 405 is configured to control, for the second period of time, the plurality of control valves 420 to operate in a sixth manner to stop inflating the other of the left vertically adjacent bladder 130 (e.g., bladders 2L and 3L) and the right vertically adjacent bladder 130 (e.g., bladders 2L and 3L) and inflate the one of the left vertically adjacent bladder 130 and the right vertically adjacent bladder 130.

In some instances, the electronic processor 405 is configured to repeatedly control the plurality of control valves 420 to operate in the fifth manner for the second period of time and in the sixth manner for the second period of time in the alternating manner for the predetermined amount of repetitions.

In some instances, in response to determining that the repeated control of the plurality of control valves 420 in the alternating manner has repeated the predetermined amount of repetitions, the electronic processor 405 is configured to control the plurality of control valves 420 to operate in the fourth manner for a fifth period of time that is shorter than the fourth period of time and longer than the second period of time. In the example shown in FIGS. 7D and 7E, the fifth period of time is one second. In some instances, the fifth period of time is between and inclusive of 1.0 seconds and 1.5 seconds. In some instances, the fifth period of time is an alternative value or within an alternate range. In some instances, the third period of time is the same as the fifth period of time.

The massage pattern 700 continues to provide massaging output up the backrest portion 105 of the vehicle seat 205 as explained below. For example, the electronic processor 405 is configured to control the plurality of control valves 420 in the first manner, the second manner, the third manner, the fourth manner, the fifth manner, and the sixth manner to provide a step toggle starting on a lower portion of the back foam 110 and moving upwards to a middle portion of the back foam 110. The electronic processor 405 also may be configured to control the plurality of control valves 420 such that the step toggle continues upward to a higher portion of the back foam 110 and then restarts at the lower portion of the back foam 110 by controlling the control valves 420 to operate in the first manner for the first period of time.

As shown in FIGS. 7A and 7B, during implementation of the massage pattern 700, bladders 1L, 1R, 2L and 2R in the lowest vertical portions/rows may be inflated for 2.5 seconds while none of the other bladders 3R-5R and 3L-5L are inflated. As shown in FIG. 7B, at the 2.5 second mark, inflation of one set of bladders 1L, 2L and 1R, 2R may stop for 0.2 seconds while inflation of the other set of bladders of 1L, 2L and 1R, 2R continues for the same 0.2 seconds. Also as shown in FIG. 7B, at the 2.7 second mark, the inflation of the sets of bladders 1, 2L and 1R, 2R switches/reverses such that the other set of bladders of 1L, 2L and 1R, 2R is stopped for 0.2 seconds and the one of the bladders 1L, 2L and 1R, 2R is inflated for the same 0.2 seconds. These two consecutive 0.2 second time periods may consecutively repeat for a predetermined number of repetitions (e.g., two more repetitions or three total instances of the two 0.2 second time periods) as shown in FIG. 7B. After the predetermined number of repetitions, at the 3.7 second mark, both sets of bladders 1L, 2L and 1R, 2R may be inflated for one second until the 4.7 second mark.

Accordingly, the first 4.7 seconds of the pattern 700 make up a first control cycle that includes inflation of bladders 1L, 2L and 1R, 2R at certain time periods. At the 4.7 second mark, a second control cycle begins that is similar to the first control cycle but that includes inflation of bladders 2L, 3L and 2R, 3R at certain time periods to gradually move massaging output up the backrest portion 105 of the vehicle seat 205. For example, during the second control cycle from the 4.8 second mark to the 9.4 second mark, bladders 2L, 3L and 2R, 3R are controlled similarly to how the bladders 1L, 2L and 1R, 2R were controlled during the first control cycle. Additional control cycles are implemented until the top two vertical portions/rows of bladders 4L, 5L and 4R, 5R implement a control cycle. After such implementation, the massage pattern 700 may repeat by again implementing the first control cycle at the lowest vertical portions/rows of bladders 130 on the backrest portion 105.

As indicated by the above explanation, in some instances of the massage pattern 700, the left first bladder 130 includes a first left low bladder 1L and a second left low bladder 2L that is above the first left low bladder 1L in the back foam 110. In some instances, the right first bladder 130 includes a first right low bladder 1R and a second right low bladder 2R that is above the first right low bladder 1R in the back foam 110. In some instances, the left vertically adjacent bladder 130 includes a first left vertically adjacent bladder 2L and a second left vertically adjacent bladder 3L that is above the first left vertically adjacent bladder 2L in the back foam 110. In some instances, the first left vertically adjacent bladder 2L is the same as the second left low bladder 2L. In some instances, the right vertically adjacent bladder 130 includes a first right vertically adjacent bladder 2R and a second right vertically adjacent bladder 3R that is above the first right vertically adjacent bladder 2R in the back foam 110. In some instances, the first right vertically adjacent bladder 2R is the same as the second right low bladder 2R.

As indicated by the above explanation of the massage pattern 700 shown in FIGS. 7A-7I, the left vertically adjacent bladder 2L, 3L includes a left next highest bladder 2L, 3L (or set of bladders 130) above the left first bladder 1L, 2L (or set of bladders 130), and the right vertically adjacent bladder 2R, 3R includes a right next highest bladder 2R, 3R (or set of bladders 130) above the right first bladder 1R, 2R (or set of bladders 130). In other words, the massage pattern 700 moves up the backrest portion 105. In other instances, the vertically adjacent bladders 130 may be vertically adjacent in a downward direction to cause the massage pattern 700 to move down the backrest portion 105. Additionally, in some instances, each of the left vertically adjacent bladder 2L, the right vertically adjacent bladder 2R, the left first bladder 1L, and the right first bladder 1R may include additional bladders 130 (e.g., a second, third, etc. bladder located in the respective vertical portion/row of the backrest portion 105) instead of a single right bladder 130 in the respective vertical portion/row and a single left bladder 130 in the respective vertical portion/row.

As shown in FIGS. 6A-6L and 7A-7I, the massage patterns 600 and 700 have many similarities. For example, in both patterns 600 and 700, the electronic processor 405 is configured to control the plurality of control valves 420 to operate in a first manner to inflate a first subgroup of bladders 130 on the back foam 110 for a first period of time. The first period of time may be at least two seconds, and the first subgroup of bladders may include a right bladder 130 and a left bladder 130.

Additionally, in both patterns 600 and 700, in response to the first period of time elapsing, the electronic processor 405 is configured to control the plurality of control valves 420 to operate in a second manner to repeatedly, for a predetermined amount of repetitions and in an alternating manner, (i) inflate the left bladder 130 and stop inflating the right bladder 130 for a second period of time and (ii) stop inflating the left bladder 130 and inflate the right bladder 130 for a third period of time. The second period of time may be between and inclusive of 0.2 seconds and 0.3 seconds, and the third period of time may be between and inclusive of 0.2 seconds and 0.3 seconds. In some instances, the second period of time and the third period of time may be the same.

Also in both patterns 600 and 700, in response to determining that the repeated control of the plurality of control valves 420 in the alternating manner has repeated the predetermined amount of repetitions, the electronic processor 405 is configured to control the plurality of control valves 420 to operate in a third manner to inflate the first subgroup of bladders 130 on the back foam 110 for a fourth period of time. The fourth period of time may be at least one second.

In some instances, the electronic processor 405 is configured to control the plurality of control valves 420 in the first manner, the second manner, and the third manner to provide a wave toggle or a step toggle starting on a first vertical portion/row of the back foam 110 and moving in a direction up or down to a second vertical portion/row of the back foam 110. In some instances, the electronic processor 405 is configured to control the plurality of control valves such that the wave toggle or the step toggle continues moving in the direction up or down by controlling the control valves 420 to inflate additional subgroups of bladders located in another vertical portion/row of the back foam 110.

In some instances (e.g., corresponding to the pattern 700), the left bladder 130 includes a first left low bladder L1 and a second left low bladder L2 that is above the first left low bladder L1 in the back foam 110. Similarly, the right bladder 130 may include a first right low bladder R1 and a second right low bladder R2 that is above the first right low bladder R1 in the back foam 110.

As indicated by FIGS. 5A-5L, 6A-6L, and 7A-7I and the corresponding explanation herein, the massage patterns described herein may start at a lower portion of the backrest portion 105 (e.g., at a lowest vertical portion/row of bladders 130 such as bladders 1R and 1L) and may gradually move upwards (i.e., up the occupant's back) to a higher portion of the backrest portion 105 (e.g., to a highest vertical portion/row of bladders 130 such as bladders 5R and 5L). After completing the massage pattern at the higher portion of the backrest portion 105, the massage pattern may restart at the lower portion of the backrest portion 105 and repeat. In other words, the massage patterns shown in FIGS. 5A-5L, 6A-6L, and 7A-7I may repeat to provide massage outputs that gradually increase in height from the lower portion of the backrest portion 105 to the upper portion of the backrest portion 105.

In other instances, similar massage patterns may start at the higher portion of the backrest portion 105 and gradually decrease in height from the higher portion of the backrest portion 105 to the lower portion of the backrest portion 105. After completing the massage pattern at the lower portion of the backrest portion 105, the massage pattern may restart at the higher portion of the backrest portion 105 and repeat. Regardless of whether the massage patterns gradually increase in height (i.e., move upwards) or gradually decrease in height (i.e., move downwards) along the backrest portion 105, the massage patterns may start at any vertical portion/row of the backrest portion 105 and move accordingly.

In some instances, the periods of time described herein are merely examples and may be longer or shorter than each other and/or than the example values and/or ranges provided herein.

Various features and aspects of the present disclosure are set forth in the following claims.

What is claimed is:

1. A vehicle seat comprising:
a frame;
a back foam configured to provide a backrest;
a plurality of adjustable pneumatic bladders positioned within the vehicle seat on an A-surface of the back foam;
a source of pressurized air;
a plurality of control valves, wherein each control valve is independently controllable to control whether the pressurized air is provided from the source to a respective bladder to allow for individual control of inflation of each bladder of the plurality of adjustable pneumatic bladders; and
an electronic processor coupled to the plurality of control valves to independently control each of the control valves, wherein the electronic processor is configured to:
control the plurality of control valves to operate in a first manner to inflate a first bladder on the back foam for a first period of time,
in response to the first period of time elapsing, control, for a second period of time that is shorter than the first period of time, the plurality of control valves to operate in a second manner to stop inflating the first bladder and inflate a first vertically adjacent bladder that is vertically adjacent to the first bladder on the back foam,
in response to the second period of time elapsing, control, for a third period of time that is shorter than the first period of time and longer than the second period of time, the plurality of control valves to operate in a third manner to stop inflating the first vertically adjacent bladder and inflate the first bladder,
repeatedly control the plurality of control valves to operate in the second manner for the second period of time and in the third manner for the third period of time in an alternating manner for a predetermined amount of repetitions,
in response to determining that the repeated control of the plurality of control valves in the alternating manner has repeated the predetermined amount of repetitions, control the plurality of control valves to operate in a fourth manner to inflate the first vertically adjacent bladder and to stop inflating the first bladder for a fourth period of time,
in response to the fourth period of time elapsing, control, for the second period of time, the plurality of control valves to operate in a fifth manner to stop inflating the first vertically adjacent bladder and inflate a second vertically adjacent bladder that is vertically adjacent to the first vertically adjacent bladder on the back foam, wherein the first vertically adjacent bladder is located vertically between the first bladder and the second vertically adjacent bladder on the back foam,
in response to the second period of time elapsing, control, for the third period of time, the plurality of control valves to operate in a sixth manner to stop inflating the second vertically adjacent bladder and inflate the first vertically adjacent bladder, and
repeatedly control the plurality of control valves to operate in the fifth manner for the second period of time and in the sixth manner for the third period of time in the alternating manner for the predetermined amount of repetitions.

2. The vehicle seat of claim 1, wherein each bladder of the plurality of adjustable pneumatic bladders includes a multi-chamber bladder with multiple chambers oriented in a stacked configuration.

3. The vehicle seat of claim 1, wherein each of the first bladder, the first vertically adjacent bladder, and the second vertically adjacent bladder include a left bladder and a right bladder.

4. The vehicle seat of claim 1, wherein the second period of time is between and inclusive of 0.2 seconds and 0.3 seconds.

5. The vehicle seat of claim 4, wherein the third period of time is between and inclusive of 0.45 second and 0.55 seconds.

6. The vehicle seat of claim 5, wherein the first period of time is between and inclusive of 2.5 seconds and 3.5 seconds, and wherein the fourth period of time is between and inclusive of 2.5 seconds and 3.5 seconds.

7. The vehicle seat of claim 1, wherein the first period of time is the same as the fourth period of time.

8. The vehicle seat of claim 1, wherein the predetermined amount of repetitions is between and inclusive of two and six.

9. The vehicle seat of claim 1, wherein the first vertically adjacent bladder includes a first next highest bladder above the first bladder, and wherein the second vertically adjacent bladder includes a second next highest bladder above the first next highest bladder.

10. The vehicle seat of claim 1, wherein the electronic processor is configured to control the plurality of control valves in the first manner, the second manner, the third manner, the fourth manner, the fifth manner, and the sixth manner to provide a wave pulse starting on a lower portion of the back foam and moving upwards to a middle portion of the back foam;
wherein the electronic processor is configured to control the plurality of control valves such that the wave pulse continues upward to a higher portion of the back foam and then restarts at the lower portion of the back foam by controlling the control valves to operate in the first manner for the first period of time.

11. A vehicle seat comprising:
a frame;
a back foam configured to provide a backrest;
a plurality of adjustable pneumatic bladders positioned within the vehicle seat on an A-surface of the back foam;
a source of pressurized air;
a plurality of control valves, wherein each control valve is independently controllable to control whether the pressurized air is provided from the source to a respective bladder to allow for individual control of inflation of each bladder of the plurality of adjustable pneumatic bladders; and
an electronic processor coupled to the plurality of control valves to independently control each of the control valves, wherein the electronic processor is configured to:
control the plurality of control valves to operate in a first manner to inflate a left first bladder and a right first bladder on the back foam for a first period of time,
in response to the first period of time elapsing, control, for a second period of time that is shorter than the first period of time, the plurality of control valves to operate in a second manner to stop inflating one of the left first bladder and the right first bladder while continuing to inflate the other of the left first bladder and the right first bladder,
in response to the second period of time elapsing, control, for the second period of time, the plurality of control valves to operate in a third manner to stop inflating the other of the left first bladder and the right first bladder and inflate the one of the left first bladder and the right first bladder,
repeatedly control the plurality of control valves to operate in the second manner for the second period of time and in the third manner for the second period of time in an alternating manner for a predetermined amount of repetitions,
in response to determining that the repeated control of the plurality of control valves in the alternating manner has repeated the predetermined amount of repetitions, control the plurality of control valves to operate in the first manner for a third period of time that is shorter than the first period of time and longer than the second period of time,
in response to the third period of time elapsing, control, for a fourth period of time, the plurality of control valves to operate in a fourth manner to inflate a left vertically adjacent bladder that is vertically adjacent to the left first bladder and a right vertically adjacent bladder that is vertically adjacent to the right first bladder on the back foam and to stop inflating the left first bladder and the right first bladder,
in response to the fourth period of time elapsing, control, for the second period of time, the plurality of control valves to operate in a fifth manner to stop inflating one of the left vertically adjacent bladder and the right vertically adjacent bladder while continuing to inflate the other of the left vertically adjacent bladder and the right vertically adjacent bladder,
in response to the second period of time elapsing, control, for the second period of time, the plurality of control valves to operate in a sixth manner to stop inflating the other of the left vertically adjacent bladder and the right vertically adjacent bladder and inflate the one of the left vertically adjacent bladder and the right vertically adjacent bladder,
repeatedly control the plurality of control valves to operate in the fifth manner for the second period of time and in the sixth manner for the second period of time in the alternating manner for the predetermined amount of repetitions, and
in response to determining that the repeated control of the plurality of control valves in the alternating manner has repeated the predetermined amount of repetitions, control the plurality of control valves to operate in the fourth manner for a fifth period of time that is shorter than the fourth period of time and longer than the second period of time.

12. The vehicle seat of claim 11, wherein each bladder of the plurality of adjustable pneumatic bladders includes a multi-chamber bladder with multiple chambers oriented in a stacked configuration.

13. The vehicle seat of claim 11, wherein the left first bladder includes a first left low bladder and a second left low bladder that is above the first left low bladder in the back foam;
wherein the right first bladder includes a first right low bladder and a second right low bladder that is above the first right low bladder in the back foam;
wherein the left vertically adjacent bladder includes a first left vertically adjacent bladder and a second left vertically adjacent bladder that is above the first left vertically adjacent bladder in the back foam, wherein the first left vertically adjacent bladder is the same as the second left low bladder;
wherein the right vertically adjacent bladder includes a first right vertically adjacent bladder and a second right vertically adjacent bladder that is above the first right vertically adjacent bladder in the back foam, wherein the first right vertically adjacent bladder is the same as the second right low bladder.

14. The vehicle seat of claim 11, wherein the second period of time is between and inclusive of 0.2 seconds and 0.3 seconds.

15. The vehicle seat of claim 14, wherein the first period of time is between and inclusive of 2.5 seconds and 3.0 seconds, and wherein the third period of time is between and inclusive of 1.0 seconds and 1.5 seconds.

16. The vehicle seat of claim 11, wherein the first period of time is the same as the fourth period of time, and wherein the third period of time is the same as the fifth period of time.

17. The vehicle seat of claim 11, wherein the predetermined amount of repetitions is between and inclusive of one and four.

18. The vehicle seat of claim 11, wherein the left vertically adjacent bladder includes a left next highest bladder above the left first bladder, and wherein the right vertically adjacent bladder includes a right next highest bladder above the right first bladder.

19. The vehicle seat of claim 11, wherein the electronic processor is configured to control the plurality of control valves in the first manner, the second manner, the third manner, the fourth manner, the fifth manner, and the sixth manner to provide a wave toggle or a step toggle starting on a lower portion of the back foam and moving upwards to a middle portion of the back foam;
wherein the electronic processor is configured to control the plurality of control valves such that the wave toggle or the step toggle continues upward to a higher portion of the back foam and then restarts at the lower portion of the back foam by controlling the control valves to operate in the first manner for the first period of time.

20. A vehicle seat comprising:
a frame;
a back foam configured to provide a backrest;
a plurality of adjustable pneumatic bladders positioned within the vehicle seat on an A-surface of the back foam;
a source of pressurized air;
a plurality of control valves, wherein each control valve is independently controllable to control whether the pressurized air is provided from the source to a respective bladder to allow for individual control of inflation of each bladder of the plurality of adjustable pneumatic bladders; and
an electronic processor coupled to the plurality of control valves to independently control each of the control valves, wherein the electronic processor is configured to:
control the plurality of control valves to operate in a first manner to inflate a first subgroup of bladders on the back foam for a first period of time, wherein the first period of time is at least two seconds, and wherein the first subgroup of bladders includes a right bladder and a left bladder,
in response to the first period of time elapsing, control the plurality of control valves to operate in a second manner to repeatedly, for a predetermined amount of repetitions and in an alternating manner, (i) inflate the left bladder and stop inflating the right bladder for a second period of time and (ii) stop inflating the left bladder and inflate the right bladder for a third period of time, wherein the second period of time is between and inclusive of 0.2 seconds and 0.3 seconds, and wherein the third period of time is between and inclusive of 0.2 seconds and 0.3 seconds, and
in response to determining that the repeated control of the plurality of control valves in the alternating manner has repeated the predetermined amount of repetitions, control the plurality of control valves to operate in a third manner to inflate the first subgroup of bladders on the back foam for a fourth period of time, wherein the fourth period of time is at least one second;
wherein the electronic processor is configured to control the plurality of control valves in the first manner, the second manner, and the third manner to provide a wave toggle or a step toggle starting on a first vertical portion of the back foam and moving in a direction up or down to a second vertical portion of the back foam;
wherein the electronic processor is configured to control the plurality of control valves such that the wave toggle or the step toggle continues moving in the direction by controlling the control valves to inflate additional subgroups of bladders located in another vertical portion of the back foam.

21. The vehicle seat of claim 20, wherein the left bladder includes a first left low bladder and a second left low bladder that is above the first left low bladder in the back foam;
wherein the right bladder includes a first right low bladder and a second right low bladder that is above the first right low bladder in the back foam.
